(19) United States
(12) Patent Application Publication
(10) Pub. No.: US 2014/0030475 A1
(43) Pub. Date: Jan. 30, 2014

(54) Interlocking Modular Shape System

(71) Applicant: Danielle Kimberly MacInnes, Ada, MI (US)

(72) Inventor: Danielle Kimberly MacInnes, Ada, MI (US)

(21) Appl. No.: 13/934,101

(22) Filed: Jul. 2, 2013

Related U.S. Application Data
(60) Provisional application No. 61/741,177, filed on Jul. 13, 2012.
(60) Provisional application No. 61/852,634, filed on Mar. 18, 2013.

(51) Int. Cl. B32B 7/08; B32B 3/30; B32B 3/06

(52) U.S. Cl. CPC B32B 7/08; B32B 3/06; B32B 3/30
USPC 428/99

(57) ABSTRACT

The present invention is a system that comprises interlocking modular shapes and a proprietary spline attachment. The system is an interchangeable containment system made up of open faced modular shapes. Each modular shape has at least one groove that runs along at least one surface of its face. Proprietary splines are used to connect (yoke) the surfaces together via the grooves. The modular shapes can be connected to each other by sliding the proprietary spline into the grooves of the two surfaces. The interlocking system allows for multiple modular shapes to be connected to each other creating larger structures. These structures are not fixed, permitting reconfigurations for alternate uses. The shapes are adaptable for varying purposes, and with the use of basic parts, allowing the system to be useable by any age and be interchangeable at any time.

### CROSS-REFERENCES TO RELATED APPLICATIONS

This application claims the benefit of priority to U.S. Provisional Application 61/741,177, filed Jul. 13, 2012, and U.S. Provisional Application 61/852,634, filed Mar. 18, 2013, and incorporates by reference in their entirety.

### BACKGROUND OF THE INVENTION

The modular shape system is an interchangeable “containment” system; a versatile system that can be used for decorating, shelving, organizing and/or playing. It is a system that can be used in all stages of life. For example, it can be used as a customizable dollhouse and can transition to a shelving system as the needs of a child grows. This makes the interlocking modular system unique because it can be classified into different industries: Toy, Furniture, and Storage.

Research shows there is a growing demand for toys that improve learning skills through logic and creative play. Toys that influence mathematical, scientific, technological, and engineering concepts are on the rise. The interlocking modular shape system implements logic and creative processing using a basic, yet complex mathematical system. When using the system it requires creative thinking to organize the modular shapes to the arrangement desired.

While multifunctional toys are becoming a consumer trend, there are a limited amount of these types of toys. Multifunctional toys are toys that grow with the child. They are transitional, creative, and can keep a child engaged for years. The interlocking modular shape system meets the consumers' demand with its ability to engage the child for years in different types of play. With its unique concept, it is usable well into adulthood. The versatile modular shape system allows the user to reconfigure the modular shapes to adapt to a variety of purposes. Therefore, the need for the product may change and the consumer can continue to use it in its new configuration.

The interlocking modular shape system is also an environmentally conscious product. Although there are no concrete statistics to show how many products are purchased, in part, because they are eco-friendly, there is a general consensus that this mindset is increasingly present in the market place. Moreover, even products that are more eco-friendly, natural, or energy efficient are still creating waste by being limited in their uses. This is one of the biggest problems in our society, the garbage we accumulate. To be truly conscience of our environment, products need to be more versatile to the consumer. This will help moderate the throw-away behavior of some consumers and reduce pollution. The interlocking modular shape system is a strong representation of a product that reduces waste.

From an investment standpoint, a product that is versatile in its uses is a good investment. When buying a product that will be used for a single purpose, the consumer spends money and will see little or no return in his purchase. The interlocking modular shape system can be bought to meet a specific demand, such as a dollhouse for a child, and when this play stage ends, the system can be reconfigured to meet another need, such as storage or an organizer at a desk. Another example is that the system can be used as a dollhouse, then reconfigured as a play kitchen or play market, then returned to a dollhouse. The consumer has made a better investment by buying one item that will meet the needs for several role play toys instead of buying each individual one.

Looking deeper into the toy industry, there are extensive toys for boys to promote engineering and math concepts, but are limited towards girls. This is the beginning of a problem where males dominate the fields of science, technology, mathematics, and engineering (STEM). According to the U.S. Department of Commerce, Economics and Statistics Administration, females are underrepresented in STEM jobs. Participation levels at universities and STEM programs show that there is a lack of involvement from the female population. The interlocking modular shape system brings the math and engineering skills to girls and boys alike where they can create and design their own imaginary play (such as a dollhouse, garage, market, kitchen, or storage bin and model display) by assembling and reassembling the boxes to the layouts they want. Girls can learn the concept of architectural design when configuring the dollhouse and use mathematical and engineering concepts every time the system is reconfigured. Creating fun ways to learn engineering concepts for both boys and girls can level the playing field for entry into these technical fields.

There is also a lack of products that can meet the needs of children as they grow, and that can also continue to meet their needs into adulthood, and that can allow the consumer to be inventive when using the product. Furthermore, of these products, there are few available that can be converted into a variety of configurations which would save consumers from purchasing individual products to meet specific needs; a concept that is economically and environmentally sound. The interlocking modular shape system meets these needs as it permits varying reconfigurations for alternate uses. The shapes are adaptable for varying purposes, allowing the system to be useable at any age and be interchangeable at any time.

### BRIEF SUMMARY OF THE INVENTION

In one aspect, the invention is a system that consists of interlocking modular shapes with a proprietary spline attachment. The system is an interchangeable containment system that may have modular shapes with the ability to rotate into different positions. The modular shape may have one or multiple faces having grooves. Each modular shapes has at least one face, and at least one groove that runs along the surface of its face. Proprietary splines are used to connect two surfaces or faces, each having a groove, fitted so that the grooves form a key way. The spline is fitted into the key way thereby, yoking the surfaces together. The modular shape may have more than one face and/or more than one groove on each face.

In another aspect, the invention may include a platform that has at least one groove running along its surface. The platform may be used mounted to a wall or left freestanding. The groove(s) of the platform can accept a proprietary spline. A modular shape(s) can be connected to the platform by sliding the proprietary spline into the grooves of two surfaces (see, for example, FIG. 1a).

In yet another aspect, the invention may be an interlocking modular shape system comprising a modular shape having at least one face and at least one groove on the face. The system may have at least two modular shapes. The modular shapes may be connected by a spline via the key way created by the grooves to receive the spline. The invention may include a platform having at least one groove along its surface. A modular shape may be connected to the platform via the key way created by the grooves and yoked together by the spline. It is further contemplated that there may be yoking of one modular shape to another or yoking of a modular shape to a platform or there may be a mixture of yoking modular shape to modular shape and yoking modular shape to a platform.

The modular shapes of the invention have at least one face and at least one groove. Modular shapes can be flat shapes and/or three-dimensional shapes. Examples of such shapes include, but are not limited to, square, rectangle, triangle, circle, ovals, L-shapes, cubes, rectangular prisms (or cuboid), triangular prisms, and pentagonal prisms. Modular shapes of the invention may have at least one open face. Modular shapes of the invention have at least one groove on at least one face. Grooves may be on multiple faces of a modular shape. A face of a modular shape may have multiple grooves.

In still another aspect, the invention permits varying configurations and the ability to reconfigure with ease for alternate uses. The shapes are adaptable for varying purposes, allowing the system to be useable at any age and be interchangeable at any time.

### BRIEF DESCRIPTION OF THE DRAWINGS

FIG. 1a depicts one embodiment of the invention where examples of modular shapes are connected to a platform.

FIG. 1b depicts one embodiment of a spline (7).

FIG. 2a depicts a frontal view of the modular shape (2) of FIG. 1a, where the open face is facing forward.

FIG. 2b depicts a side view of the modular shape (2) of FIG. 1a, where the open face is facing down.

FIG. 2c depicts a back view of the modular shape (2) of FIG. 1a, where the groove is crossing the center of (bisecting) a face.

FIG. 3a depicts a more detailed view of a groove of the modular shape (2) of FIG. 1a.

FIG. 3b depicts a more detailed cross sectional view of the spline (7) of FIG. 1b.

FIGS. 4a-4g depict examples of modular shapes and the placement of their grooves.

FIG. 5 depicts another example of modular shape of the invention.

### DETAILED DESCRIPTION OF THE INVENTION

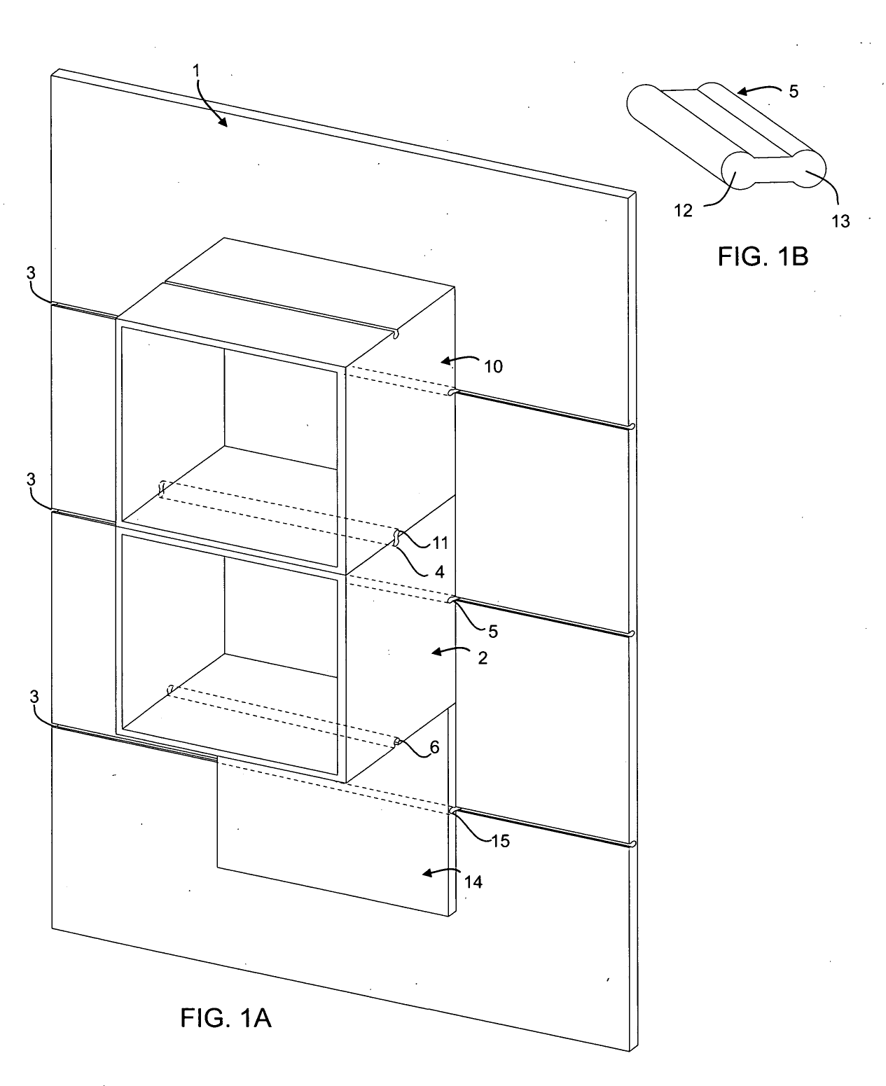

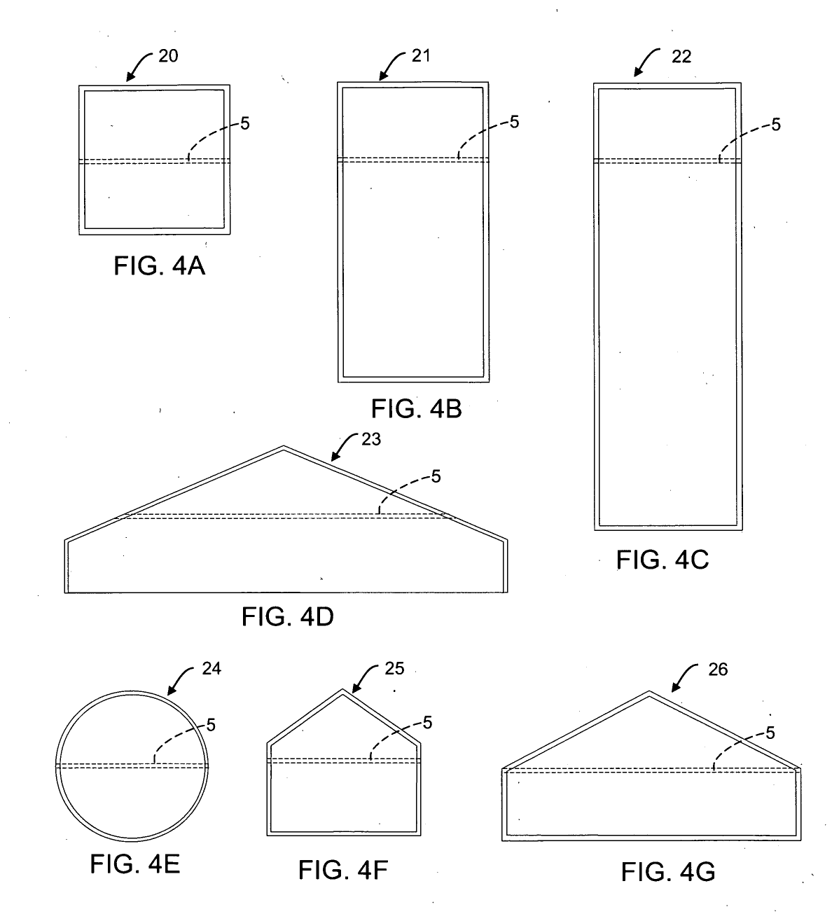

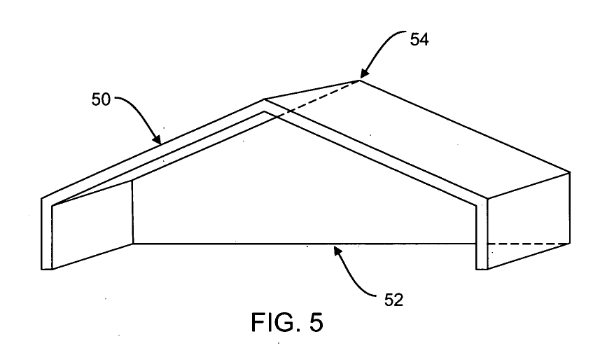

In one embodiment of the invention, as depicted in FIG. 1a, the interlocking modular shape system can be configured on a platform (1). A platform (1) has at least one groove on its face (3) which accepts a circular flange (12) of a proprietary spline (7). A groove of a modular shape when aligned with a groove of a platform, or groove of another modular shape, creates a key way through which a proprietary spline can be inserted, thereby yoking them together. In another embodiment, the platform can be mounted to a wall and oriented so that its grooves can run horizontally or vertically. The modular shapes (2,14) can then slide across the platform into place via the spline. Some example of a modular shape are depicted in FIGS. 4a-4g. The modular shapes can be added to the platform into any configuration desired.

In yet another embodiment of the invention, the interlocking system can be built into a structure which is free standing (i.e., resting on the floor or table with or without the use of a platform) by connecting modular shapes (2) having at least one groove (4) on their faces which would accept a circular flange (12) of the proprietary spline (7) to another modular shape. The modular shape (2) can interlock to another modular shape (10) at the region where the two shapes accept the spline's circular flanges (12, 13) when inserting the spline (7) into the key way of the grooves (4,11) as depicted in FIG. 1a. The connections between modular shapes may be made, and the systems created, without the use of a platform. Multiple shapes can be added to the system in the same connective fashion.

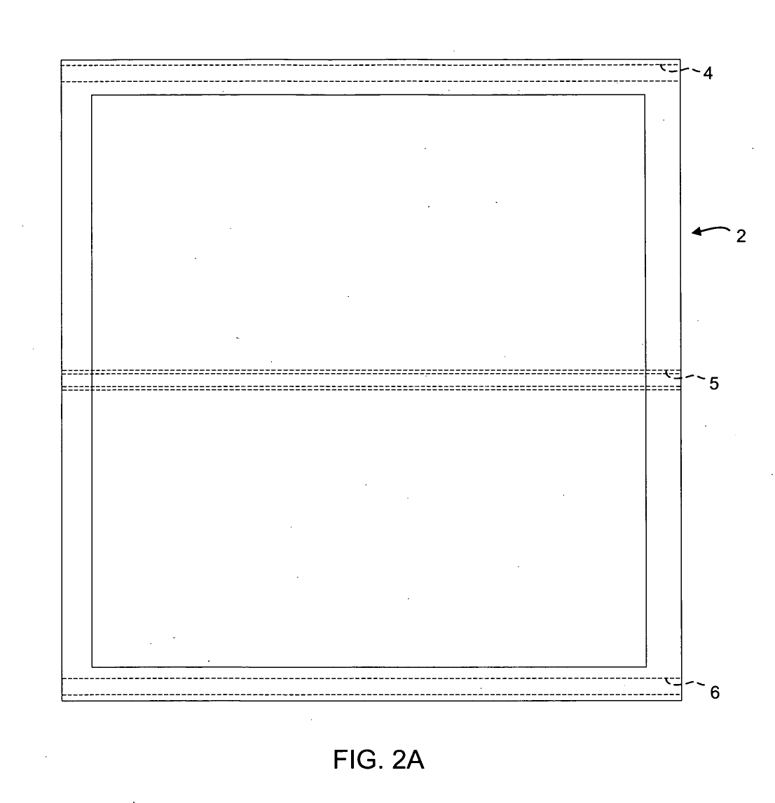

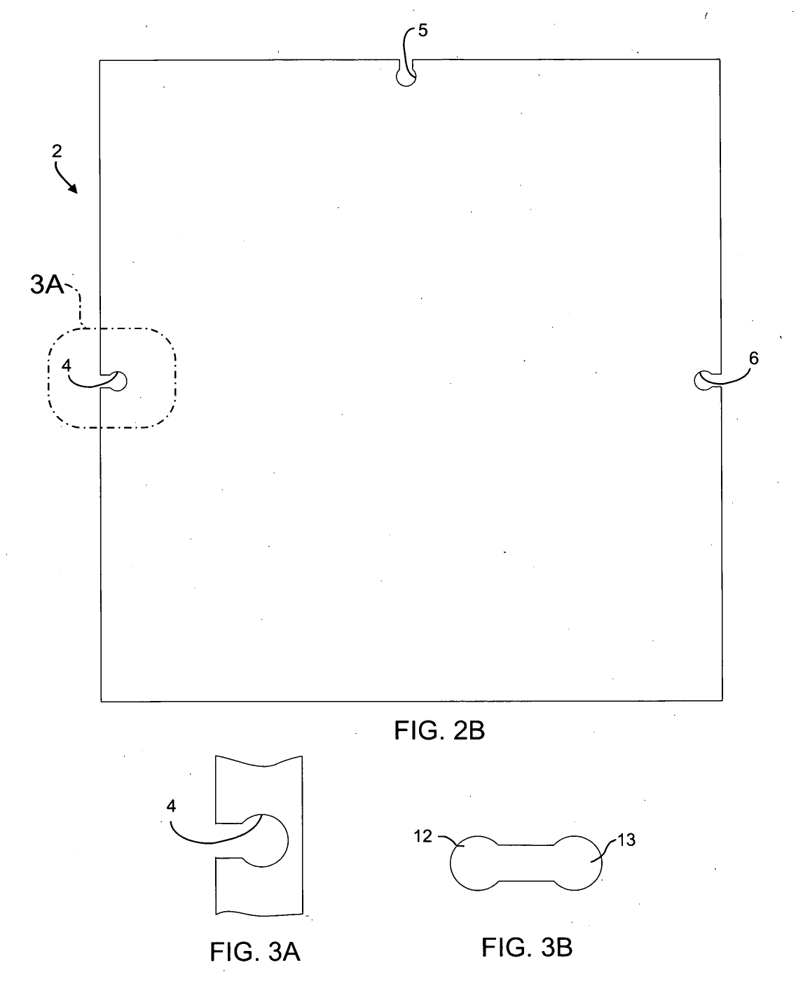

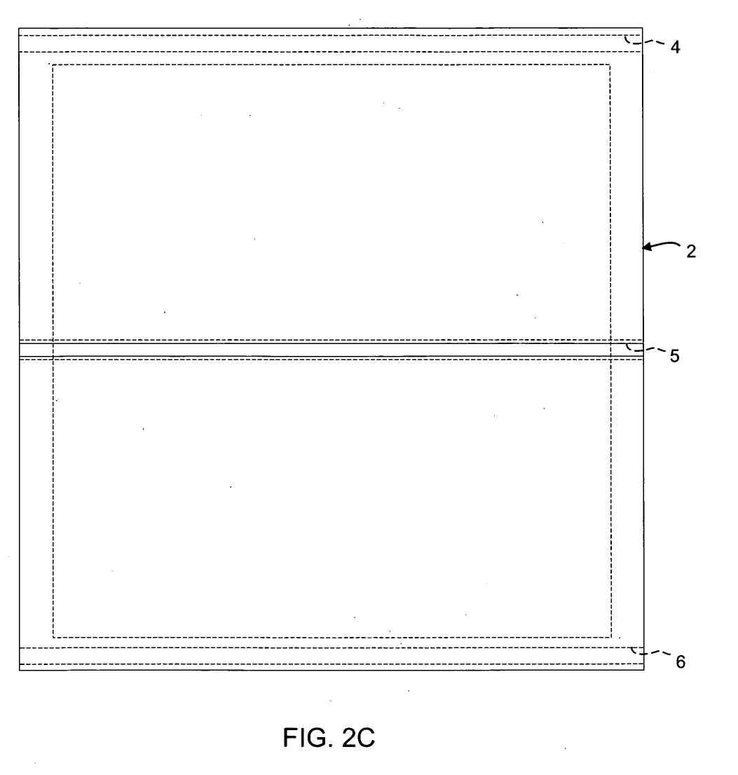

As depicted in FIGS. 2a, b, and c, a modular shape (2) can be an open face cube with at least one groove (4,5,6), on more than one face (FIG. 2b), which can allow the cube to be rotated and connected so that the open face of the cube can be on different planes (upward, frontal, downward). In other embodiments, the shapes can be a rectangular prism as depicted in FIGS. 4 b and c, or a pentagonal prism shown in FIGS. 4d, f, and g, or other shapes such as a hexagonal prism or an octagonal prism.

An example of a modular shape can be a cube having the dimensions of 8 inches in height by 8 inches in width by 8 inches in depth. Examples of rectangular prisms may have a height and/or a width of 8, 16, 24, 32, 40, 48, 56, or 64 inches or more. These dimensions are for illustrative purposes and are not meant to be exclusive.

In yet other embodiments, the invention can be a modular shape, wherein the modular shape is a 2 dimensional slab (14), also known as a flat shape, having a groove on at least one surface (15) of its face. In still other embodiments, the invention can be a modular shape wherein the modular shape is in an “L” shape and has at least one groove on its face. The shape may have grooves on each face.

In the embodiment shown in FIG. 1a, the invention is drawn to a 3 dimensional cube shape (2). The cube shape is depicted in FIG. 2b showing one open face, with at least one groove on the top, back, and bottom of its faces. The grooves on different faces allow the box to be places with its open face facing forward, upward, or downward. In another embodiment of the invention, the 3 dimensional shape can be a rectangular cube with grooves running horizontally and vertically as shown in FIGS. 4b and 4c. The horizontal and vertical grooves allow the shape to be attached in a tall and narrow orientation, or a short and wide orientation.

In another embodiment of the invention, the modular shapes can be a pentagonal prism with a groove running along its back face as depicted in FIGS. 4d, 4f, and 4g. In still other embodiments, a pentagonal prism may be inverted so that the apex is now at the bottom. Further, a pentagonal prism (50) may have two open faces, an example of which is shown in FIG. 5. A first open face may be the face opposite the face having the groove which attaches to the platform, e.g., the back or pentagonal face (52). An optional second open face may be the face opposite the apex (54).

In one embodiment of the invention, the platform has at least one groove running parallel to an edge. In another embodiment of the invention, the platform has 2, 3, 4, 5, 6 or more grooves running parallel to an edge. The distance between parallel grooves may be 3, 4, 5, 6, 7, 8, 9, 10, 11, 12, 13, 14, 15, 16, 17, 18 inches or more apart.

In another embodiment of the invention, the modular shape has a groove running parallel to an edge of a face of the modular shape. The groove may be placed equidistant to the edge and its opposite edge or vertex. For example, a modular shape being 8 inches in height may have a groove running along horizontally at 4 inches from the top and 4 inches from the bottom. However, it is also contemplated that the groove may be closer to one edge or vertex than its opposite edge or vertex. A modular shape of the invention may have more than one groove on its face allowing the user the choice of placing the modular shape in the middle, so that the groove of the platform bisects the modular shape, or placing the modular shape higher than or lower than its placement in the middle as previously described. In this manner, the tops of the modular shapes along a groove need not create a single, level line. Additionally or alternatively, placement of modular shapes, either side-by-side or on top of each other, may be flush to each other, or they may be separated by space as desired by the user.

In another embodiment, the proprietary spline can be the connective mechanism for yoking the modular shapes to the platform, and the modular shapes to other modular shapes. The spline shown in FIG. 1b, is inserted into the key way of the grooves (5,3). In the view of one example of a spline shown in FIG. 1b, the spline consists of a rectangular stem (16) with two symmetrical circular flanges (12,13) on each side of it. The spline and grooves can be machine fabricated with tolerances permitting ease of insertion and removal into the key way.

In another embodiment of the invention, the proprietary splines (7), modular shapes, and other accessories can be made from wood or recycled plastic, but other types of materials that can be used include, but are not limited to, metal, carbon fiber, etc. The invention can be painted, in whole or in part, with colored or chalkboard paint, additionally or alternatively, other parts of the system can be left in their natural state without dyes or urethane.

In one embodiment of the invention, the platform (1) and/or modular shapes (2,14) may be constructed of 12 layer birch plywood. This durable wood may be chosen for its reputation in strength and minimal movement over the years. However, other types of material that can be used include, but are not limited to, plastic, metal, wood, cork, carbon fiber etc. Use of different materials will be apparent to one of ordinary skill in the art.

The system can be sold in a variety of kits that can be collected to make larger displays and increase its possibilities of its uses. The system also has separate accessories which enhance the unique and creative ways this invention can be used. It can be a toy, table, shelves, or an organization station, to name just a few examples.

1. An interlocking modular shape system comprising:
a modular shape having at least one face and at least one groove on said face;
a platform having at least one groove along its surface; and
a spline connecting said modular shape to said platform.

2. The system of claim 1, wherein the modular shape has at least one open face.

3. The system of claim 1, wherein the face of the modular shape has a groove running parallel to a top horizontal edge.

4. The system of claim 3, wherein the modular shape is any one of a cube, a rectangular prism, a pentagonal prism, a triangular prism, or an L-shaped form.

5. The system of claim 3, wherein the groove of the modular shape is on the face that is opposite an open face.

6. The system of claim 1, wherein the modular shape is a cube having the dimensions of 8 inches in height, 8 inches in width, and 8 inches in depth.

7. The system of claim 1, wherein the grooves of the platform are 8 inches apart and run parallel to each other.

8. The system of claim 1, wherein the face of the modular shape has a groove running parallel to an edge of said face and wherein the groove is placed equidistant to said edge and its opposite edge or vertex.

9. The system of claim 6, wherein the groove on the face of the cube is 4 inches from a top edge and 4 inches from a bottom edge of the face.

10. The system of claim 7, wherein a height of the modular shape, a width of the modular shape, or both the height and width of the shape is one of 8, 16, 24, 32, 40, 48, 56, or 64 inches.

11. A modular shape comprising at least one face and at least one groove on said face.

12. The modular shape of claim 11, wherein said modular shape has at least one open face.

13. The modular shape of claim 12, wherein the modular shape is any one of a cube, a rectangular prism, a triangular prism, a pentagonal prism, or an L-shaped form.

14. The modular shape of claim 12, wherein the groove of said modular shape is on the face that is opposite the open face.

15. The modular shape of claim 12, wherein the groove is on at least one face adjacent to the open face.

16. The modular shape of claim 11, wherein said modular shape is a cube having the dimensions of 8 inches in height, 8 inches in width, and 8 inches in depth.

17. The modular shape of claim 11, wherein the face of the modular shape has a groove running parallel to an edge of said face and wherein the groove is placed equidistant to said edge and its opposite edge or vertex.

18. The modular shape of claim 16, wherein the groove on the face of the cube is 4 inches from a top edge and 4 inches from a bottom edge of the face.

19. The modular shape of claim 11, wherein a height of the modular shape, a width of the modular shape, or both the height and width of the shape is one of 8, 16, 24, 32, 40, 48, 56, or 64 inches.

20. A spline consisting of a thin strip having symmetrical circular flanges running the length of said strip wherein the circular flanges are received by grooves on a modular shape or platform.

21. The spline of claim 20, wherein the strip consisting of a rectangular stem located between said symmetrical circular flanges wherein the length has tolerances permitting ease of insertion when yoking two said surfaces together.

21. The spline of claim 20, wherein the strip is made of wood, plastic, or metal.
